(19) United States
(12) Patent Application Publication
(10) Pub. No.: US 2024/0001531 A1
(43) Pub. Date: Jan. 4, 2024

(54) Multipurpose Device (Fixture) for Carrying and Transporting Objects

(71) Applicant: NISHMAT ISRAEL LTD., Jerusalem (IL)

(72) Inventors: Aryeh ROITMAN, (US); Aryeh EIDERMAT, Jerusalem (IL)

(21) Appl. No.: 18/038,155

(22) PCT Filed: Nov. 22, 2020
(86) PCT No.: PCT/IL2020/051205

§ 371 Date: May 22, 2023

(51) Int. Cl. B25J 1/04

(52) U.S. Cl. CPC B25J 1/04

(57) ABSTRACT

The object of the present invention is the presented multipurpose device (fixture) for carrying and transporting items packed in soft bags (made of plastic, paper, etc. (including network (mesh) bags)) that makes it easy to carry and transport items in soft bags (with or without flexible handles) using: flexible handles, (and/or) the resistant force of the upper part of the packaging, (and/or) a node in the upper part for locking (retaining) the bag on the device and/or using friction force for locking (holding) the bag on the device and reducing the load on the locking element.

The device combines maximum convenience in fastening and moving packages, with a minimum size, much smaller than all other devices for the same purpose. That allows you to carry the device in your pocket.

The width of the gaps between the holders (in the narrowest part of the device) or between the holders and the frame (for the outermost holders) is such that:
the handle of the bag (or the upper part of the bag having no handles) can easily pass into the fixing groove through this gap, but
it does not fall out of the fixing groove or out of the handle, and
it can be easily (with minimal effort) removed from the fixing groove (and from the handle).

The shape of the fixing groove also contributes to easy removal of the bag from the handle.

This is one of the very important features and improvements suggested by this invention.

In all similar inventions known to us, the holders, as is clear from the figures and descriptions, have such a shape that bags may fall out of the holders if you release or put the bag-carrying device down, or even in the process of carrying.

The surfaces of the device can be used for long-term advertising, instead of spending extra natural resources on multiple printing of one-use paper ads of the same content, that is placed on the device's surface (in this way it does not substitute for all paper advertisements but can partially replace them, thus saving natural resources and reducing pollution).

Implementations of the device can be transformed one into another as needed.

Experimental samples of the device showed its efficiency and confirmed its expedience.

### FIELD AND BACKGROUND OF THE INVENTION

The proposed invention can be classified as a device (fixture) for the multiple transferring and transportation of items packed in soft bags. Soft bags are the main packaging type when we buy food in stores. During transporting items in a soft bag, there emerges concentrated pressure on fingers exerted by the bag handle (if the bag has handles) or by the upper part of the bag gripped by the hand. Carrying and transporting items in plastic bags creates environmental problems and requires significant resources for disposal of waste (used plastic). In addition, cramming several soft bags with food into one bag results in squeezing the bought products and, in some cases, degradation of their quality. Besides, the number of the used soft bags increases. To facilitate transportation of soft bags, various designs of devices (handles) are used, but they are not widely spread, since they do not solve all the tasks and problems.

There are a number of well-known patented designs of devices for carrying small plastic bags (packages).

Thus, American U.S. Pat. No. 4,772,059, 1987, presents a device in the form of an open frame, the lower part of which, in the place of the opening, is bent from two sides. When the bag's handles are inserted, the bent ends of the frame are compressed, ensuring its integrity (closure). This design does not reduce centralization of the stress from the bag's handles on the lower part of the frame and does not distribute the load evenly over the lower part of the frame.

German patent DE 3819580, 1989, presents a device the lower part of which has one or two grooves for flexible handles of a soft bag or package. When such a device is taken down, the flexible handles of the bag may come out of the groove, and the items may spill out of the bag.

British patent GB 2237187, 1991, presents a device made as a curved rod the bent ends of which are attached to the flexible part (belt) resting on the shoulder. This design frees the hands but complicates the attachment of packages having flexible handles, since to add another bag you need to disconnect and reattach the flexible part (belt). In addition, this device does not have a locking element, and, when being lowered onto the floor, the bags may open up.

Israeli patent 99200, 1991, presents a shaped frame with an opening at the top and a groove at the bottom. The disadvantage of this device is the inconvenience of carrying bags, as in the process one has to force together the two brackets constituting the upper part of the frame. In addition, the groove for flexible handles concentrates bags, creating lateral loads (pressure) on each of them. This patent can be considered a prototype of the proposed invention.

Russian patent RU 2017445, 1994, presents a device in the form of a rigid handle with a groove where the flexible handle of the bag is inserted. To lower the bag onto the floor in this case, one will also need an additional locking element.

Russian patent RU 2062594, 1996, presents an oval frame to which flexible handles of a bag are fastened with a loop. In this device the load is concentrated on the center of the frame, while bags also press upon each other laterally.

Russian patent RU 2161432, 2001, presents a device in the form of a cross beam to the ends of which flexible handles of bags are attached. Such device is difficult to carry as it tends to deviate from its horizontal position.

Russian patent RU 2326575, 2006, presents a flexible device for carrying bags having flexible handles, which, like the previous one, concentrates the bags' load and provokes lateral pressure of the bags on each other.

The analysis of the known patents shows that attaching bags to the described therein devices is only possible if bags have flexible handles. The above devices do not decrease the lateral pressure of the bags on each other. The use of the known devices does not improve the environmental situation, since the number of the used plastic bags is not reduced.

The proposed device eliminates these shortcomings, expands the scope of application allowing to carry bags that do not have flexible handles, improves the environmental situation reducing the number of the plastic bags used: it allows carrying bags that do not have flexible handles, rather than to group them into big bags with flexible handles and only then fasten those to the device—in this way the device eliminates the intermediate element (link).

The fact that the proposed device uses friction to reduce the load on the locking member enhances its reliability and performance. The proposed device has a number of implementations that facilitate the processes of lifting bags up the stairs and otherwise transporting them.

### Objects and a Brief Summary of the Invention

The object of the present invention is the presented multipurpose device (fixture) for carrying and transporting items packed in soft bags (made of plastic, paper, etc.) that makes it easy to carry and transport items in soft bags (with or without flexible handles) using: flexible handles, (and/or) the resistant force of the upper part of the packaging, (and/or) a node in the upper part for locking (retaining) the bag on the device and/or using friction force for locking (holding) the bag on the device and reducing the load on the locking element (FIG. 1, FIG. 14, FIG. 18, FIG. 20, FIG. 20, FIG. 22, FIG. 26, FIG. 27)

For Implementations of the device on the pictures of FIG. 20, FIG. 21, FIG. 22, FIG. 23, FIG. 26, FIG. 27:
The above mentioned multipurpose device for carrying and transporting items packed in soft bags (made of plastic, paper, etc.) consists of a closed rigid frame the upper part of which functions as a support for the hand, and the lower part of the frame has a number of holders, mounted with gaps and directed upwards, to which soft bags can be attached.
The said device may also have some holders in the lower and mid-lateral parts of the mentioned rigid frame.
There are rigid guides and retention (locking) grooves providing for attaching and fastening of bags.
The locking grooves (spots) can be rectangular, round, or oval; the teeth may be drop-shaped, diamond-shaped, or trapezoidal.
Soft bags that do not have handles are retained on the frame by locking them with the help of a knot in locking grooves;
Soft bags with flexible handles are held on the bottom part of the frame and attached to the teeth.

The device may have flexible support parts to enable a person to carry it, with a load of bags, on the shoulder or on the back.

The device can be equipped (fitted) with an ordinary or telescopic support cane (tube) to facilitate the stages of transporting the load (stopping, climbing the stairs).

To facilitate the transportation of the load, the cane (tube) can be equipped (fitted) with a wheel.

For the convenience of holding the cane during stops and transportation, the wheel is made in the shape of a polyhedron.

Distribution (attachment) of bags with intervals over the length of the lower part of the frame reduces the lateral pressure of the bags on each other, thus increasing the quality of carrying.

The proposed device improves the environmental situation by reducing the number of plastic bags used for carrying and transporting [loads] and expands the scope of use allowing to carry bags both with and without handles.

For Implementations of the device on the pictures of FIG. 1, FIG. 14, FIG. 18:
The above mentioned multipurpose device for carrying and transporting items packed in soft bags (made of plastic, paper, etc.) consists of a closed rigid frame the upper part of which functions as a support for the hand, and under the lower part of the frame there are a number of console drop-shaped holders (teeth), installed with gaps and directed downwards, to which soft bags, passing through the frame, bending around its lower part, leaning on it and reducing the load on the teeth due to friction force, are attached.
Between the teeth of the device there are retaining (locking) grooves and rigid guides that provide for attaching and fastening bags on the teeth.
The locking grooves (spots) can be rectangular, round, or oval; the teeth may be drop-shaped, diamond-shaped, or trapezoidal.
Soft bags having flexible handles are held on the lower part of the frame and attached to the teeth, and the load on a tooth is reduced due to the friction force emerging between the lower part of the frame and the soft bag enveloping it;

Soft bags that do not have handles are retained on the frame by friction force when they bend around the bottom of the frame and by locking in the retaining grooves;
Soft bags that do not have handles but have a thickening in the upper part of the package are retained on the frame by friction force when they bend around the bottom of the frame and by locking in the retaining grooves, with locking added due to the thickening of the upper part of the bag and locking it in the locking grooves.

The device may have flexible support parts to enable a person to carry it, with a load of bags, on the shoulder or on the back.

The device can be equipped (fitted) with an ordinary or telescopic support cane (tube) to facilitate the stages of transporting the load (stopping, climbing the stairs).

To facilitate the transportation of the load, the cane (tube) can be equipped (fitted) with a wheel.

For the convenience of holding the cane during stops and transportation, the wheel is made in the shape of a polyhedron.

The implementation of the device can have the lower part of the frame made with additional holes and locking grooves intended to lock and retain soft bags.

Distribution (attachment) of bags with intervals over the length of the lower part of the frame reduces the lateral pressure of the bags on each other, thus increasing the quality of carrying.

The proposed device improves the environmental situation by reducing the number of plastic bags used for carrying and transporting [loads] and expands the scope of use allowing to carry bags both with and without handles.

The surfaces of the device can be used for long-term advertising, instead of spending extra natural resources on multiple printing of one-use paper ads of the same content, that is placed on the device's surface (in this way it does not substitute for all paper advertisements but can partially replace them, thus saving natural resources and reducing pollution).

Implementations of the device can be transformed one into another as needed.

Experimental samples of the device showed its efficiency and confirmed its expedience.

### BRIEF DESCRIPTION OF THE DRAWINGS

The implementations of the device on the pictures of FIG. 20, FIG. 21, FIG. 22, FIG. 23, FIG. 26, FIG. 27.

FIG. 20, FIG. 22, FIG. 26, FIG. 27. General view of the device.

FIG. 4. Upper part (handle) of the device, with a groove.

FIG. 5.2 Rectangular groove for attaching soft bags.

FIG. 6.2 Round groove for attaching soft bags.

FIG. 7.2 Drop-shaped console holder (tooth).

FIG. 8.2 Diamond-shaped console holder (tooth).

FIG. 12. Carrying the device with packages on the shoulder.

FIG. 13. Carrying the device with packages on the back.

FIG. 14. Device with a cane.

FIG. 15. Telescopic cane.

FIG. 16. Cane with a wheel.

FIG. 17. Polyhedron wheel.

FIG. 24. Cross-section of the device with a groove in the upper part of the frame.

FIG. 25. Cross-section of the device in the form of a flat frame.

The implementations of the device on the pictures of FIG. 1, FIG. 14, FIG. 18

FIG. 1. General view of the device.

FIG. 2. Cross-section of the device with a groove in the upper part of the frame.

FIG. 3. Cross-section of the device in the form of a flat frame.

FIG. 4. Upper part (handle) of the device, with a groove.

FIG. 5.1 Rectangular groove for attaching soft bags.

FIG. 6.1 Round groove for attaching soft bags.

FIG. 7.1 Drop-shaped console holder (tooth).

FIG. 8.1 Diamond-shaped console holder (tooth).

FIG. 9. Fastening soft bags to the device.

FIG. 10. Fastening a soft bag having flexible handles.

FIG. 11. Fastening a soft bag without flexible handles.

FIG. 12. Carrying the device with packages on the shoulder.

FIG. 13. Carrying the device with packages on the back.

FIG. 14. Device with a cane.

FIG. 15. Telescopic cane.

FIG. 16. Cane with a wheel.

FIG. 17. Polyhedron wheel.

FIG. 18. Device with holes in the lower part of the frame.

FIG. 19. Fastening soft bags to some of the holders through the opening of the device, and fastening soft bags to other holders not through the opening of the device. Device surfaces used for advertising.

### DESCRIPTION OF THE INVENTION

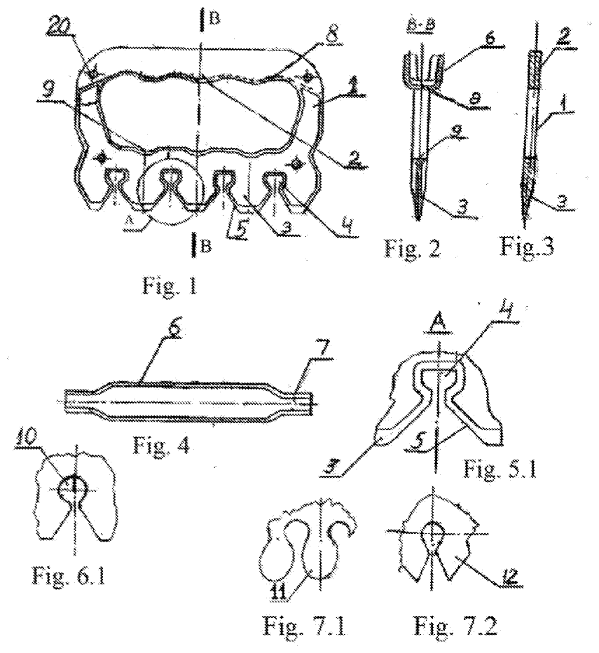

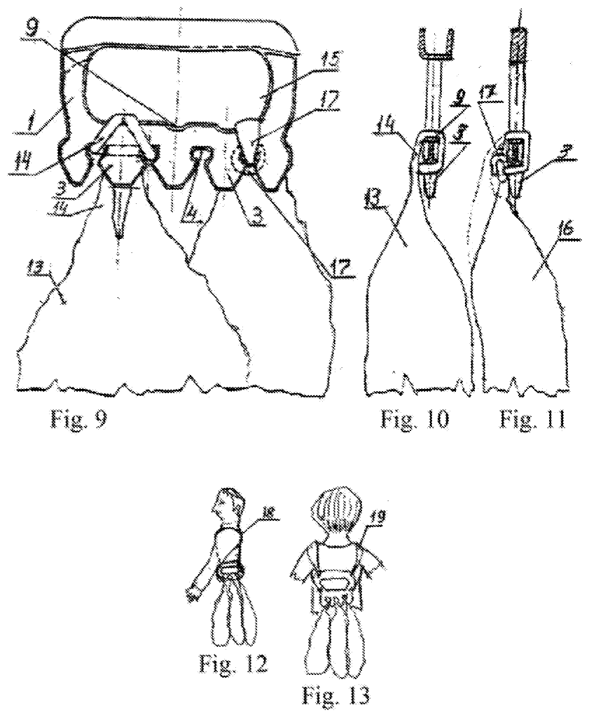

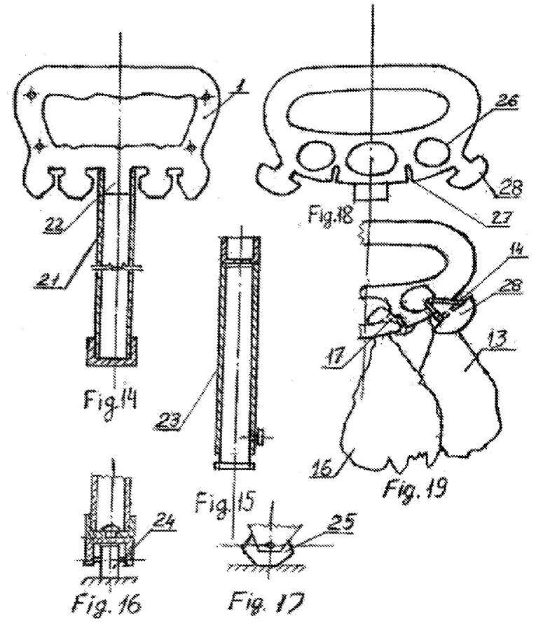

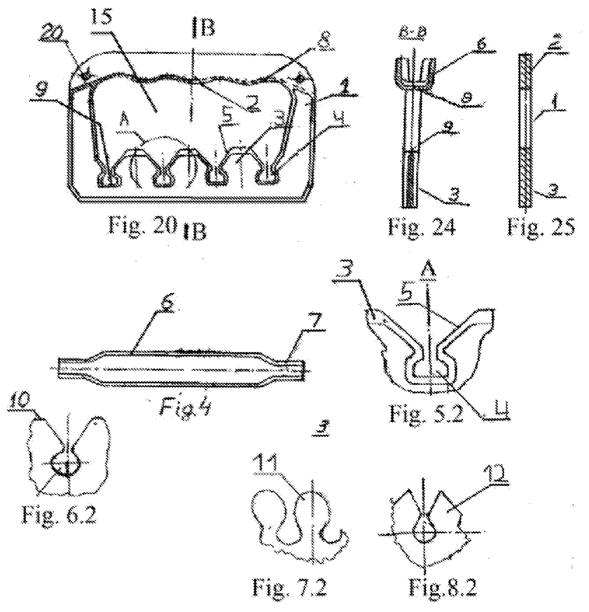

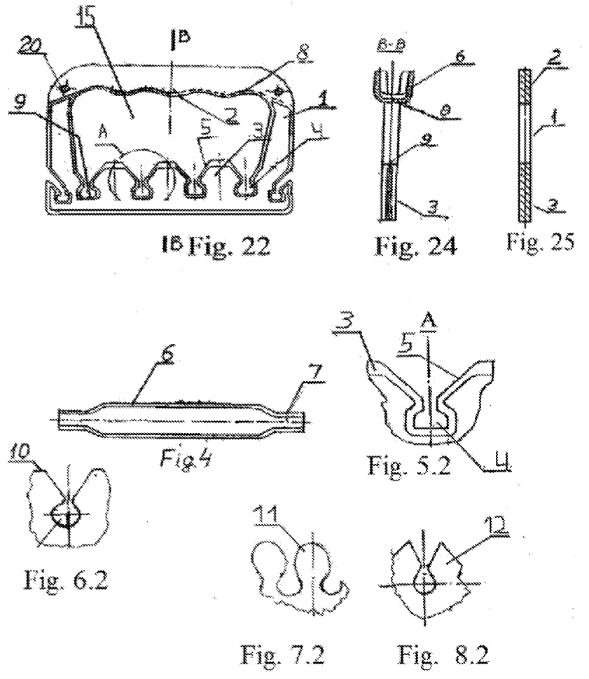

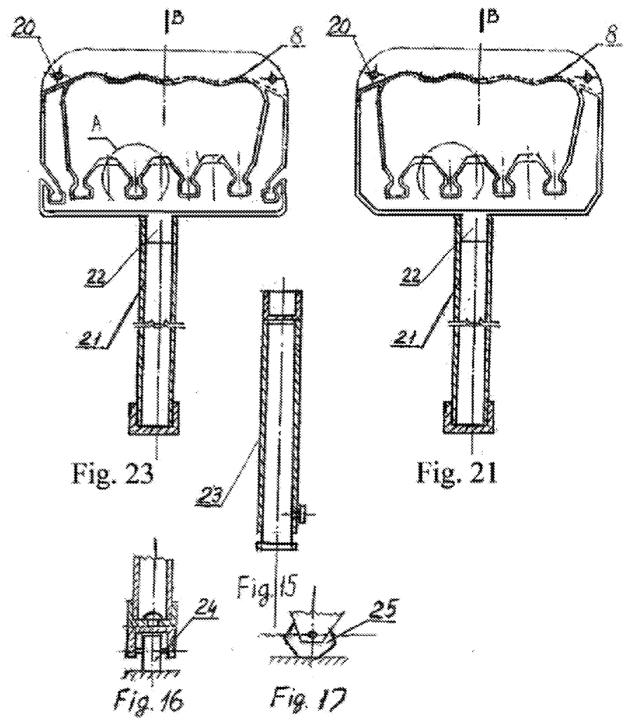

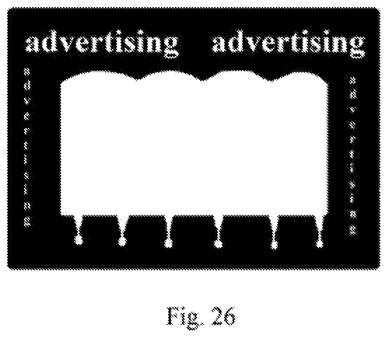

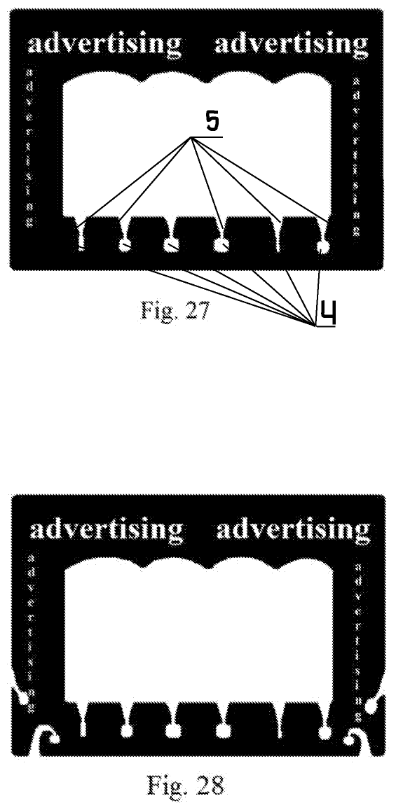

### The Implementations of the Device on the Pictures of FIG. 20, FIG. 21, FIG. 22, FIG. 23, FIG. 26, FIG. 27.

FIG. 20, FIG. 21, FIG. 26, FIG. 27

The multipurpose device (device for carrying and transporting items packed in soft bags) consists of a rigid frame the upper part of which is a support for the hand (with a handle in its upper part); on the lower part of the frame it has a number of holders directed up mounted with gaps directed downwards—the rigid guides and locking (retaining) grooves providing for attaching and fastening of bags.

The locking grooves (spots) can be rectangular, round, or oval, larger or smaller (depending on the thickness of the bag and the required method of fixing of bag to the handle).

The inner surface of the frame in its upper part may have depressions for fingers, and in its lower part—depressions to distribute the soft bags being carried. When attaching a soft bag without a flexible handle to the device, the upper part of the bag is compressed, brought through the opening, then it goes through the guides and the locking groove and is retained in it by a knot.

The gaps should be wide enough to let the bags go through but narrow enough to retain them.

Gaps in different designs of the device can have different as well as locking grooves (spots) can be rectangular, round, or oval, larger or smaller (depending on the thickness of the bag and the required method of fixing of bag to the handle, for transporting bags of different density (thickness) and dimensions).

FIG. 22, FIG. 23

An expanded and partially modified version of the device described in the previous paragraphs is a multipurpose device for carrying items packed in soft bags (made of plastic, paper, etc.), consisting of a closed rigid frame, the upper part of which is a support for the hand, while the lower part of the frame has a series of holders directed up mounted with gaps directed downwards, and some of the holders directed sideways and/or downwards with gaps directed in the corresponding direction and downwards; to some of which soft packs, going through the frame and leaning on it, are attached, and to the other part of these holders other knotted soft packs are attached, without the need to pass through the frame. Along with this, some of the holders can be used in both ways: it is possible to reliably transport both soft bags without handles, and soft bags that have flexible handles.

FIG. 20, FIG. 21, FIG. 22, FIG. 23, FIG. 26, FIG. 27

The multipurpose device (fixture for carrying and transporting items in soft bags (FIG. 20, FIG. 22, (also this will be true for FIG. 22, FIG. 23)) consists of a rigid frame 1 with a handle 2 in its upper part and a number of console teeth 3 directed up (FIG. 20, FIG. 21) or directed up and sideways (FIG. 22, FIG. 23) in the lower part of the frame. Between the teeth 3 there are retaining (locking) grooves 4 and rigid guides 5. The handle may have a grooved shape 6 (FIG. 2) or a thickness equal to the thickness of the frame (FIG. 3). The grooved handle may have a narrowing 7 in the groove (FIG. 4) on both sides. The inner surface of the frame in its upper part may have depressions 8 (FIG. 20, FIG. 22, FIG. 21, FIG. 23, FIG. 26, FIG. 27 (also this will be true for FIG. 1, FIG. 14, FIG. 18)) for fingers.

When attaching a soft bag with a flexible handle to the device, flexible handles go through the opening 15 of the frame 1, pass through the guides 5 (FIG. 20, FIG. 22, (also this will be true for FIG. 21, FIG. 23, FIG. 27), FIG. 5.2) (are slipped over the tooth 3) and fixed in the grooves 4, leaning on the lower part of the frame (depressions 9).

When attaching a soft bag without a flexible handle to the device, the upper part of the bag (with the knot) is compressed, go through the opening 15 of the frame 1, pass through the guide 5 (FIG. 20, FIG. 22 (also this will be true for FIG. 21, FIG. 23, FIG. 26, FIG. 27), FIG. 5.2) (are slipped over the tooth 3) and fixed in the grooves 4, leaning on the lower part of the frame (depressions 9).

FIG. 5.2 shows rectangular-shaped locking grooves 4, and FIG. 6.2 shows round locking grooves. FIG. 7.2 shows drop-shaped teeth 11, and FIG. 8 shows diamond-shaped teeth 12.

The device loaded with soft packages (bags) can be fastened on the shoulder (FIG. 12) with the help of flexible elements (for example, a belt) 18 (FIG. 12), or on the back (FIG. 13) with the help of flexible elements 19. The flexible elements can be attached to frame 1 through open-end holes 20 (FIG. 20, FIG. 22 (also this will be true for FIG. 21, FIG. 23)).

The device can be equipped with a support cane 21 inserted into a special prong 22 (FIG. 21, FIG. 23).

The design of the cane can be telescopic (FIG. 15). The support cane facilitates the process of carrying when stopping or climbing stairs. Canes 21 or 23 can be equipped with a round wheel 24 (FIG. 16) or a polyhedron wheel 25 (FIG. 17).

This design allows you to transfer soft bags with or without flexible handles, as well as more reliably distribute the bags over the length of the device. The use of the proposed device for carrying soft bags with garbage or waste seals the soft bag, preventing environmental pollution.

The gaps should be wide enough to let the bags go through but narrow enough to retain them.

Gaps in different designs of the device can have different as well as locking grooves (spots) can be rectangular, round, or oval, larger or smaller (depending on the thickness of the bag and the required method of fixing of bag to the handle), for transporting bags of different density (thickness) and dimensions.

### The Implementations of the Device on the Pictures of FIG. 1, FIG. 14, FIG. 18

The multipurpose device (fixture for carrying and transporting items in soft bags (FIG. 1, FIG. 14) consists of a rigid frame 1 with a handle 2 in its upper part and a number of console teeth 3 directed downwards in the lower part of the frame. Between the teeth 3 there are retaining (locking) grooves 4 and rigid guides 5.

The handle may have a grooved shape 6 (FIG. 2) or a thickness equal to the thickness of the frame (FIG. 3). The grooved handle may have a narrowing 7 in the groove (FIG. 4) on both sides. The inner surface of the frame in its upper part may have depressions 8 (FIG. 1, FIG. 14) for fingers, and depressions in its lower part 9 (FIG. 1, FIG. 14) for distributing soft bags to be carried.

FIG. 5.1 shows rectangular-shaped locking grooves 4, and FIG. 6.1 shows round locking grooves. FIG. 7.1 shows drop-shaped teeth 11, and FIG. 8.1 shows diamond-shaped teeth 12. Fastening soft bags to the device is shown in FIG. 9, FIG. 10, and FIG. 11. A soft bag 13 (FIG. 9) having flexible handles 14, is attached to the device as follows: flexible handles 14 go through the opening 15 of the frame 1, bend around it and, leaning on the lower part of the frame (depressions 9), pass through the guides 5 (FIG. 1 (also this will be true for FIG. 14), FIG. 5.1), are slipped over the tooth 3 and fixed in the grooves 4. In this case, the load on the tooth is reduced due to frictional force emerging when the flexible handle 14 bends around the lower part of the frame and rests on the frame. FIG. 10 shows a cross-section of the handle 14 of the soft package 13 fastened to the tooth 5. When the soft package 16 without the flexible handle is attached to the device, its upper part 17 is compressed (FIG. 9), is thrown through the opening 15, passes through the guides 5 (FIG. 11) and the retaining groove 4 (FIG. 9) and is held in it by the thrust forces of the compressed part of the package (bag) and by the friction force of the upper part 17 of the bag against the lower part of the frame around which it is tightened.

The device loaded with soft packages (bags) can be fastened on the shoulder (FIG. 12) with the help of flexible elements (for example, a belt) 18 (FIG. 12), or on the back (FIG. 13) with the help of flexible elements 19. The flexible elements can be attached to frame 1 through open-end holes 20 (FIG. 1 (also this will be true for FIG. 14, FIG. 18)).

The device can be equipped with a support cane 21 inserted into a special prong 22 (FIG. 14).

The design of the cane can be telescopic (FIG. 15). The support cane facilitates the process of carrying when stopping or climbing stairs. Canes 21 or 23 can be equipped with a round wheel 24 (FIG. 16) or a polyhedron wheel 25 (FIG. 17).

Implementations of the device (FIG. 18, FIG. 19) feature the lower part of the frame with additional holes 26 and retaining grooves 27. In this case, a soft bag 13 with flexible handles 14 is attached through the hole 26 to the tooth 28, and a soft bag 16 goes through the opening 26 in the upper part 17 and is fixed in the locking groove 27 of the frame.

The gaps should be wide enough to let the bags go through but narrow enough to retain them.

Gaps in different designs of the device can have different as well as locking grooves (spots) can be rectangular, round, or oval, larger or smaller (depending on the thickness of the bag and the required method of fixing of bag to the handle, for transporting bags of different density (thickness) and dimensions, with flexible handles or knot or without with flexible handles or knot).

This design allows you to transfer soft bags with or without flexible handles, as well as more reliably distribute the bags over the length of the device. The use of the proposed device for carrying soft bags with garbage or waste seals the soft bag, preventing environmental pollution.

### (For all Implementations of the Device)

This feature makes it possible to reliably transport both soft bags without handles, and soft bags that have flexible handles, thus expanding the application scope of the device.

The device loaded with soft packages (bags) can be attached to one's shoulder or back with the help of flexible parts (for example, a belt). Flexible parts can be attached to the frame of the device through the open-end holes.

The device can be equipped with a support cane.

The cane can be telescopic. The support cane facilitates the process of carrying when stopping or climbing the stairs. Canes can be equipped with a wheel—round or polyhedral.

This design allows you to transfer soft bags both with flexible handles and without them, as well as distribute more reliably the bags over the length of the device. The use of the proposed device for carrying soft bags with garbage or waste seals the soft bag thus preventing environmental pollution.

### Ways to Create a Device.

The device can be easily and simply manufactured in several ways. Among them, the simplest and cheapest are stamping from metal or strong plastic.

### Additional Comments on the Device and on the Value and Patentability of the Invention

We see it necessary to emphasize that our invention features at least 4 types of properties and/or improvements and/or changes that are not present in other devices for carrying and transporting objects and/or that significantly improve other devices.

1. The width of the gaps between the holders

The width of the gaps between the holders (in the narrowest part of the device) or between the holders and the frame (for the outermost holders) is such that:
the handle of the bag (or the upper part of the bag having no handles) can easily pass into the fixing groove through this gap, but
it does not fall out of the fixing groove or out of the handle, and
it can be easily (with minimal effort) removed from the fixing groove (and from the handle).

The shape of the fixing groove also contributes to easy removal of the bag from the handle.

This is one of the very important features and improvements suggested by this invention.

In all similar inventions known to us, the holders, as is clear from the figures and descriptions, have such a shape that bags may fall out of the holders if you release or put the bag-carrying device down, or even in the process of carrying.

To solve this problem, some inventors suggest equipping their devices with a lock.

However, adding a lock:
makes using the device more complicated: the holders should be first locked and then unlocked, which is especially problematic if each holder is equipped with a lock;
makes the production of the device too expensive and complicated.

Besides, adding a lock to the device indicates that:
inventors tried to solve the problem of bags falling out but failed to do that without using locks;
by suggesting to equip their device with a lock (inherently or as an additional version of the device), inventors actually testify that, without a lock, bags can fall out of the device.

In other words, positioning the holders in such a way that the bag's handle (or the upper part of the bag having no handles) can easily pass into the fixing groove through the gap between the holders, but would not fall out of the fixing groove and out of the handle—this method, in all its simplicity, has not been proposed in any invention (although, as we mentioned, there were attempts to solve this problem and even suggestions to equip the device with a lock to this end). Similarly, no one has ever suggested bringing the upper part of the holders (hooks) closer to the frame where they are mounted.

In any case, such a proposal is not included in the claims of any patents known to us.

All this implies that the proposed solution, however simple it seems to be, was not obvious to average-skilled specialists or even to inventors.

2. The device makes it possible to carry a bag having a knot tied at its top

The locking groove (between the holders or, for the outmost holders, between the holder and the handle) is large enough to allow the upper part of the bag to fit into it but small enough to prevent the bag from falling out of the holder. We also suggested various sizes of fixing grooves and gaps between holders for bags of various thicknesses. This is another important feature of our invention.

In all the devices known to us, the holders (hooks), as can be seen in the figures, have holes of such a size that the bag knot (in case the bag is tied up with a knot) can pass through this hole and fall out of it, at least a thin bag with a knot.

In any case, none of the claims of the patents known to us contains a proposal to make a hole in the holder of such a size that would prevent a bag tied with a knot from falling out.

3. In all the devices with a closed line of the frame* known to us, holders directed upwards* are hooks of various shapes. Each hook has three approximately equal parts: the front part, the middle part with a hole, and the back part which is the hook's bearing part.

In our case, the entire holder is used to retain a handled bag. Moreover, a significant part of the weight falls directly on the frame, which means that the load on the holder is even less. Consequently, the holder in our device, which can hold the same maximum weight as a holder in other devices, requires several times (!) less material.

*We do not consider here devices consisting of two separate units—a belt and a carrying unit—since they are much more expensive and difficult to manufacture; besides, such devices are apt to turn over. In any case, even if there is no advantage as compared to them concerning claim 4, our invention has a number of other advantages over them.

4.

4.1. The version of the device with holders directed upwards.

We are not aware of any other invention where the holders would be directed upwards inside the frame. This design saves a lot of space, and, therefore, makes our device much more compact, which means:
it is more convenient;
it requires much less material to be manufactured.

4.2. The version of the device with holders directed downwards has two additional advantages:
it allows to carry bags having no handles or knots;
the load on the holders is even less, and therefore, their strength, at the same material consumption, is even higher than the strength of holders in other devices.

1. The multipurpose device (for example FIG. 20, FIG. 21, FIG. 26, FIG. 27) (fixture) for carrying and transporting items in soft bags (made of plastic, paper, etc. (including network (mesh) bags)), consists of a rigid frame the upper part of which is a support for the hand (with a handle in its upper part); on the lower part of the frame it has a number of holders directed up mounted with gaps—the rigid guides and locking (retaining) grooves to which soft bags are fastened through the frame, leaning on it and retained in it by flexible handles or a knot.
The gaps (should be) what is mentioned above are wide enough to let the bags go through but narrow enough to retain them.
Gaps in different designs of the device can have different as well as locking grooves (spots) can be rectangular, round, or oval, larger or smaller (depending on the thickness of the bag and the required method of fixing of bag to the handle, for transporting bags of different density (thickness) and dimensions, with flexible handles or knot).

2. The multipurpose device (for example FIG. 1, FIG. 14, FIG. 18) (fixture) for carrying and transporting items in soft bags (made of plastic, paper, etc. (including network (mesh) bags)), consisting of a closed rigid frame, the upper part of which is a support for the hand, having a number of console drop-shaped holders (teeth) under the lower part of the frame, directed downwards, mounted with gaps, to which, passing through the frame, bending around its lower part, leaning on it and reducing the load on the teeth due to friction force, soft packages are attached.
The gaps (should be) what is mentioned above are wide enough to let the bags go through but narrow enough to retain them.
Gaps in different designs of the device can have different as well as locking grooves (spots) can be rectangular, round, or oval, larger or smaller (depending on the thickness of the bag and the required method of fixing of bag to the handle, for transporting bags of different density (thickness) and dimensions, with flexible handles or knot or without with flexible handles or knot).

3. An expanded and partially modified version of the device described in the previous paragraphs is a multipurpose device for carrying items packed in soft bags (FIG. 22, FIG. 23, FIG. 28) (made of plastic, paper, etc. (including network (mesh) bags)), consisting of a closed rigid frame, the upper part of which is a support for the hand, while the lower part of the frame has a series of holders directed up mounted with gaps directed downwards, and some of the holders directed sideways and/or downwards with gaps directed in the corresponding direction and downwards; to some of which soft packs, going through the frame and leaning on it, are attached and retained in it by a knot, and to the other part of these holders other knotted soft packs are attached, without the need to pass through the frame. Along with this, some of the holders can be used in both ways: it is possible to reliably transport both soft bags without handles, and soft bags that have flexible handles.
The gaps (should be) what is mentioned above are wide enough to let the bags go through but narrow enough to retain them.
Gaps in different designs of the device can have different as well as locking grooves (spots) can be rectangular, round, or oval, larger or smaller (depending on the thickness of the bag and the required method of fixing of bag to the handle, for transporting bags of different density (thickness) and dimensions, with flexible handles or knot).

4. The multipurpose device according to clauses 1; 3. consists of a rigid frame the upper part of which is a support for the hand (with a handle in its upper part); on the lower part of the frame it has a number of holders (without grooves (spots)) directed up mounted with gaps directed downwards.

5. The multipurpose device according to clauses 1; 2; 3; 4. where the locking grooves (spots) can be rectangular, round or oval.

6. The multipurpose device according to clause 1; 2; 3; 4. the teeth of which may be drop-shaped, diamond-shaped or trapezoidal.

7. The multipurpose device according to clause 1; 2; 3; 4. where soft bags having flexible handles are retained on the lower part of the frame and attached to the teeth.

8. The multipurpose device according to clauses 1; 2; 3; 4. where soft bags without handles are retained on the frame by locking with the help of a knot in the locking grooves.

9. The multipurpose device according to clause 1; 2; 3; 4. where some of soft bags having flexible handles are retained on the lower part of the frame and attached to the teeth, and some of soft bags without handles are retained on the frame by locking with the help of a knot in the locking grooves.

10. The multipurpose device according to clauses 1; 2; 3; 4. that may have supporting flexible parts for carrying the device with packages on the shoulder or on the back.

11. The multipurpose device according to clauses 1; 2; 3; 4. equipped (fitted) with an ordinary or telescopic supporting cane (tube) to facilitate the stages of transporting the load (stopping, climbing the stairs).

12. The multipurpose device according to clauses 1; 2; 3; 4. where, to facilitate the transportation of the load, the tube (cane) is equipped with a wheel, including where, for the convenience of holding the cane during stops and transportation, the wheel is made in the shape of a polyhedron.

13. The multipurpose device according to clauses 2. where the grooves between the holders in the device for carrying soft bags, as well as the grooves between the frame and the holders closest to the frame are of such a size that bags having no handles are retained in the groove by the friction force that does not allow the bag to slip through the groove.

14. The multipurpose device according to clauses 1; 2; 3; 4. having a design where the lower part of the frame has additional openings and locking grooves which lock and retain soft bags.

15. The multipurpose device according to clause 2, in which soft bags having flexible handles are held on the lower part of the frame and attached to the teeth. At the same time, the load on the tooth is reduced due to friction force emerging between the lower part of the frame and the soft package enveloping it.

16. The multipurpose device according to claim 2, where soft bags without handles are held onto the frame by to friction force when they repeatedly bend around the lower part of the frame and by locking in the retaining grooves.

17. The multipurpose device according to clauses 1; 2; 3; 4. where the holders in the device for carrying soft bags are spaced in such a way that bags can pass freely enough between them but, at the same time, they cannot fall out if the carrying device is released or put down.

18. The multipurpose device according to clauses 1; 2; 3; 4. where the grooves in the device for carrying soft bags, located between the holders or between the frame and the holders closest to the frame, are of such a size that the knot of a bag, even of a small one, cannot pass through the hole in the groove.

19. The multipurpose device according to clauses 1; 2; 3; 4. where the device for carrying soft bags has grooves of different sizes allowing the user to fix bags tied with a knot (and having no handles) of different sizes and plastic densities, so that the knot of a bag, cannot pass through the hole in the groove.

20. The multipurpose device according to clauses 1; 2; 3; 4. where the holders of the device for carrying soft bags, that are a parts of the single frame (and not an assembly consisting of several elements) and mounted inside this frame.

21. The multipurpose device according to clauses 1; 2; 3; 4. where the grooves in the device for carrying soft bags are of such a shape that a bag can be removed from the groove by the user with a slight effort directed upwards.

22. The multipurpose device according to clauses 1; 2; 3; 4. where the holders in the device for carrying soft bags are arranged in such a way that bags having handles rest on the lowest part of the holder, at the place where the holder is attached to the frame, and not on the middle part of the holder.

23. The multipurpose device according to clauses 1; 2; 3; 4. where the holders in the device for carrying soft bags are mounted in such a way that the main load from the bags falls on the supporting frame (directly, and not just because the holders are attached to the frame).
